(19) United States
(12) Patent Application Publication
(10) Pub. No.: US 2017/0369199 A1
(43) Pub. Date: Dec. 28, 2017

(54) TIERED PIZZA TRAY SUPPORT AND PIZZA INGREDIENT CATCH DEVICE

(71) Applicants: David L. Dierberger, Yorktown, VA (US); Leslie W. Storhaug, Yorktown, VA (US)

(72) Inventors: David L. Dierberger, Yorktown, VA (US); Leslie W. Storhaug, Yorktown, VA (US)

(21) Appl. No.: 15/195,022

(22) Filed: Jun. 28, 2016

(51) Int. Cl. B65D 1/34; B65D 25/24; A47J 43/00

(52) U.S. Cl. CPC B65D 1/34; A47J 43/00; B65D 25/24

(57) ABSTRACT

An apparatus for supporting and surrounding a tray holding a circular dough base of a pizza so as to intercept and retain food particles and splatter as food ingredients are being deposited on the dough base. The apparatus includes multi-tiered platforms and upright walls of progressively greater diameter, to receive pizza trays bearing pizza dough of different nominal sizes. The platforms or walls or both have finger holes to enable ejection of an assembled pizza. The platforms and upright walls are rotatably mounted to a base, so that the pizza dough can be rotated as food ingredients are deposited thereon. Four or more tiers may be provided.

### RELATED APPLICATIONS

This application claims priority in accordance with 35 U.S.C. §119(e) to U.S. Provisional Patent Application Ser. No. 61/186,559 for A PIZZA MAKING TOOL THAT SAVES TIME AND PREVENTS FOOD WASTE WHEN MAKING PIZZA filed Jun. 30, 2015 and which is included herein in its entirety by reference thereto.

### FIELD OF THE INVENTION

The present invention pertains to food making apparatus, and more particularly, to a device for preventing loss of particulate and fluid food components being added to a solid base of a food such as an unbaked or partially baked pizza shell.

### BACKGROUND OF THE INVENTION

Preparing a pizza for baking entails adding diverse ingredients to a typically circular raw or partially baked dough base (i.e., shell). The ingredients typically include a tomato based sauce, at least one type of cheese, typically in comminuted form, such as shredded or crumbled, and various meat, seafood, fruit, and vegetable toppings. The toppings are also typically comminuted so as to enable a person to bite from the baked final pizza.

These diverse ingredients may be dispensed manually, such as by sprinkling the ingredients by hand, or in large scale commercial operations, automatically, using equipment which typically drops food ingredients over the dough base.

Because rapidly completed food ingredient applications are economically more productive and efficient, the step of adding the various ingredients may be expedited, whether performed manually or automatically. However, as the rate of application increases, the operation is susceptible to becoming increasingly messy, as ingredients may be dropped inaccurately. Automated equipment, if moving rapidly, may scatter dispensed food ingredients inaccurately. A certain amount of dispensed food ingredients may fall from the dough base, creating an objectionable mess.

It would, therefore, be advantageous to provide an apparatus to improve dispensing of food ingredients onto pizza dough and other food products

### SUMMARY OF THE INVENTION

The present invention addresses the above need by providing an apparatus suited to surrounding the circular dough base of a pizza so as to intercept and retain food particles and splatter. A stepped, multi-tiered form receives pizza dough placed on a pan. The form has vertical walls which intercept food particles and splatter that would otherwise be lost and create a mess in the working environment. The form is rotatably mounted to a base, so that the pizza dough can be rotated. This permits food dispensing to be performed from only one position, or from a limited number of positions above the dough base. By contrast, without the novel apparatus, a user would be obliged to move his or her hand over the entire dough base. Automated equipment faces a similar situation. Rotating the dough base and providing encircling vertical walls immediately surrounding the dough base eliminates most loss and waste of dispensed food ingredients.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a side elevational, schematic view of the tiered pizza tray support and pizza ingredient catch device in accordance with the invention;

FIG. 2 is a top plan, schematic view of the tiered pizza tray support and pizza ingredient catch device of FIG. 1;

FIG. 3 is a side perspective, cross-sectional, schematic view of the tiered pizza tray support and pizza ingredient catch device of FIGS. 1 and 2; and

FIG. 4 is a side elevational, cross sectional, schematic, environmental view of the tiered pizza tray support and pizza ingredient catch device of FIGS. 1, 2 and 3.

### DETAILED DESCRIPTION OF THE PREFERRED EMBODIMENT

The present invention provides an apparatus for supporting and rotating raw or partially baked pizza “shells of multiple predetermined diameters supported on trays and for controlling overflow of pizza sauce and other toppings onto an adjacent countertop.

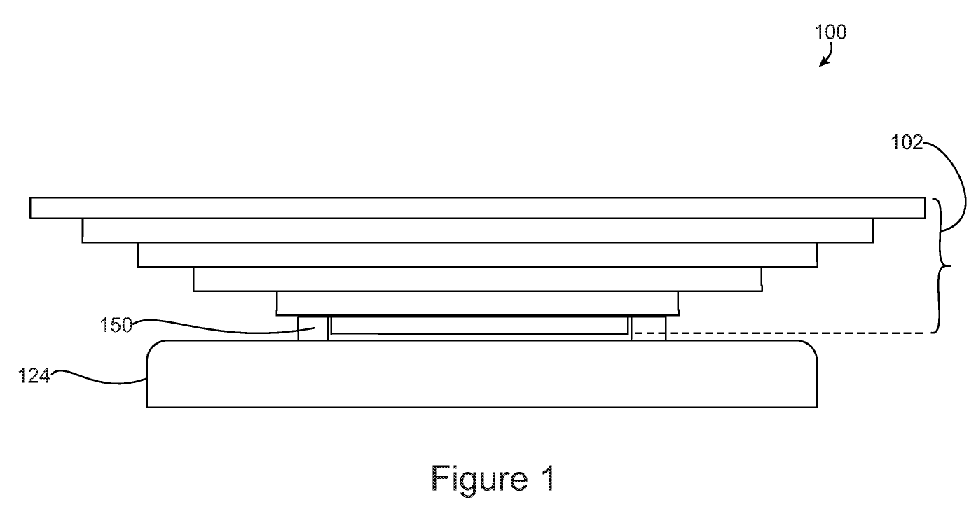

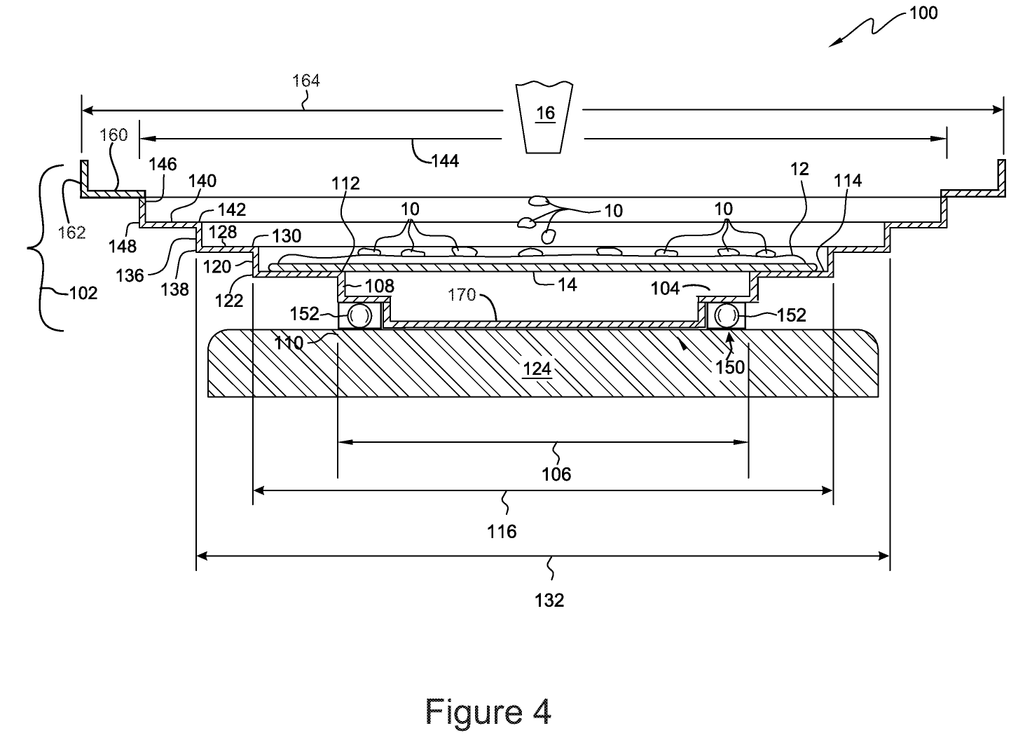

Referring first to FIG. 1, there is shown a side elevational, schematic view of the pizza ingredient catch device in accordance with the invention, generally at reference number 100. The tiered pizza tray support and pizza ingredient catch device 102 is rotatively supported on a base 124 by an intervening bearing 150. Bearing 150 is best seen in FIG. 4.

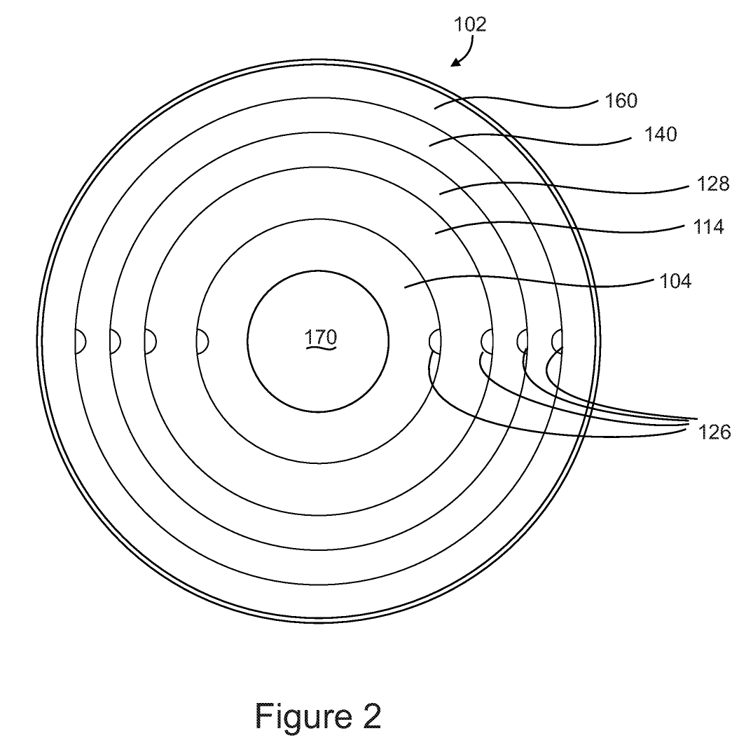

Referring now also to FIG. 2, there is shown a top plan, schematic view of the upper portion 102 of the tiered pizza tray support and pizza ingredient catch device of FIG. 1. Four support areas of increasing diameter 104, 114. 128. 140 are disposed to support pizza trays or the like, best seen in FIG. 4, of various, typically standard, diameters. A fifth “support area” 160 is typically not used to support a tray. Rather, “support area” 160 serves as a catch tray for overflowing food particles 10, best seen in FIG. 4.

A lower portion 170 of the tiered pizza tray support and pizza ingredient catch device 102 serves as a bearing flange support. It will be recognized by those of skill in the art that the upper portion 102 of the tiered pizza tray support and pizza ingredient catch device may be configured for non-standard diameters. It will be further recognized that fewer or more tiers than the four tiers chosen for purposes of disclosure are possible. Consequently, the invention is not considered limited to any particular diameters or any number of tiers. Rather, the invention is intended to include any diameters or number of tiers.

A series of finger lift holes 126 are disposed at the outer perimeter of each support area 114, 128, 140, 160 that allow a user to lift a pizza tray vertically upward and out of pizza tray support and pizza ingredient catch device 102.

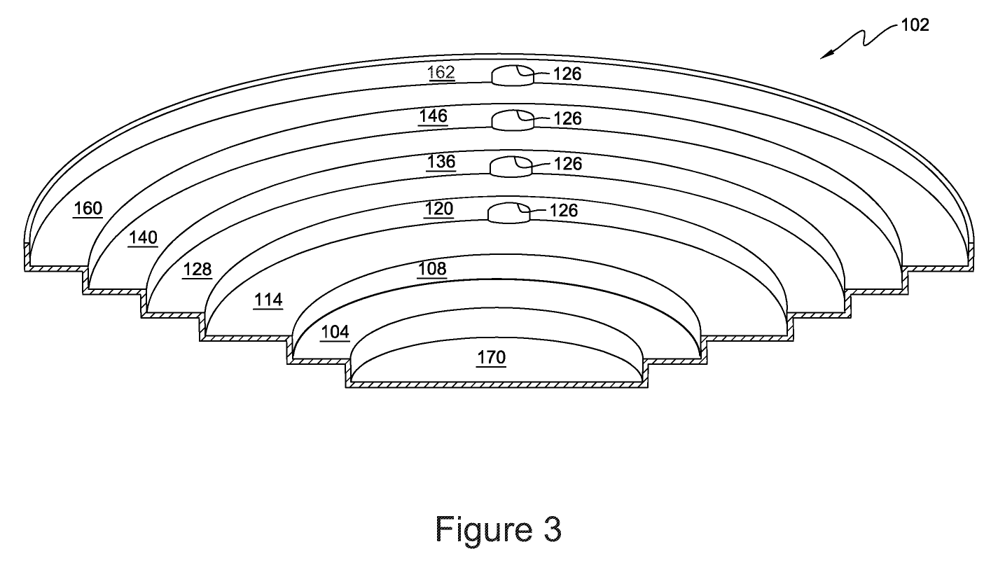

Referring now also to FIG. 3, there is shown a side perspective, cross-sectional, schematic view of the tiered pizza tray support and pizza ingredient catch device 100 of FIGS. 1 and 2. Vertical walls 108, 120, 136, 146 and 162 associated with respective support areas 104, 114, 128, 140, 160 may readily be seen. In addition, the relationship of finger holes 126 to support areas 114, 128, 140, 160 and vertical walls 120, 136, 146, 162 are readily apparent.

Referring now also to FIG. 4, there is shown a side elevational, cross sectional, schematic, environmental view of the pizza tray support and pizza ingredient catch device, hereinafter “device” 100 of FIGS. 1,2, and 3.

Device 100 clearly shows support areas 104, 114, 128, 140, 160 with associated vertical walls 108, 120, 136, 146, 162. A pizza tray 14 is shown resting of support area 114. A food base 12, typically either raw or partially baked pizza dough, is disposed on an upper surface of pizza tray 14.

A dispensing device shown schematically at reference number 16 is shown dispensing food particles 10 that represent any type of food that might be dispensed onto food base 12. These may include, but are not be limited to, oil, pizza sauce, meats, vegetables, cheese, etc.

Note that upstanding vertical wall 120 associated with support area 114 prevents splatter (not shown) of food ingredients 10 being dispensed onto a food base 12, typically pizza dough.

None of food particles 10, food base 12, pizza tray 14 nor food dispenser 16 form any part of the invention and are only included to more clearly illustrate one intended use of the novel device 100.

A lowest portion of device 100 provides a contact surface and centering device 70 that rests in a hollow region inside bearing chase 150.

Device 100 typically comprises a combined, stepped support and splatter arresting wall 102 comprising a first tier horizontal support surface 104 having a first tier diameter 106 and a first tier vertical wall 108 projecting upwardly from a perimeter 110 of first tier horizontal support surface 104. First tier vertical wall 108 includes a first upper edge 112.

Device 100 may comprise a second tier horizontal support surface 114 having a second tier diameter 116 greater than first tier diameter 106, and a second tier vertical wall 120 projecting upwardly from a second tier perimeter 122 of second tier horizontal support surface 114. Particle retaining device 100 may comprise a base 124 rotatably coupled to combined support and splatter arresting wall 102.

Although device 100 is not limited to pizza making, food base 12 is shown as pizza dough resting on a pan 14. Particles 10 (e.g., pizza toppings) are shown being dispensed from a dispenser 16, also forming no part of the present invention, although of course particles 10 could be dispensed by hand. Combined support and splatter arresting wall 102 may be rotated during dispensing of particles 10, so that dispenser 16 need not be moved as much as would be required if combined support and splatter arresting wall 102 and food base 12 were stationary.

Second tier vertical wall 120 prevents particles 10 from falling off food base 12. This enables collection and subsequent use of food ingredients which might otherwise fall to a floor or otherwise be lost to use.

Unless otherwise indicated, the terms “first”, “second”, etc., are used herein merely as labels, and are not intended to impose ordinal, positional, or hierarchical requirements on the times to which these terms refer. Moreover, reference to, e.g., a “second” item does not either require or preclude the existence of, e.g., a “first” or lower-numbered item, and/or, e.g., a “third” or higher-numbered item.

Both first tier horizontal support surface 104 and second tier horizontal support surface 114 typically are circular in a top plan view. This accommodates traditional circular or round foods, allowing for close fit with second tier vertical wall 120.

First tier vertical wall 108 may have diameter 106 in a range of three to four inches, and second tier vertical wall 120 may have diameter 116 in a range of seven to eight inches. Dimensions are exemplary, and may be selected to accommodate commonly used tray 14 diameters.

At least one finger hole 126 is disposed in at least one of second tier horizontal support surface 114 and second tier vertical wall 120. Finger holes 126 enable pan 14 and food base 12 to be elevated above a horizontal supports surface (e.g., second tier horizontal support surface 114, as illustrated) by inserting a finger or a slender object (neither shown and forming no part of the present invention) into finger hole 126, then grasping pan 14 by hand from above, to remove the completed pizza for placement in an oven (not shown).

It should be noted at this point that orientational terms such as upwardly and above refer to the subject drawing as viewed by an observer. The drawing figures depict their subject matter in orientations of normal use, which could obviously change depending on how device 100 is held or used. Therefore, orientational terms must be understood to provide semantic basis for purposes of description only, and do not imply that their subject matter can be used only in one position.

Device 100 may further comprise a third tier horizontal support surface 128 coupled to a second tier upper edge 130 of second tier vertical wall 120. Third tier horizontal support surface 128 may include a third tier diameter 132 greater than second tier diameter 116 of second tier horizontal support surface 114, and a third tier vertical wall 136 projecting upwardly from a third tier perimeter 138 of third tier horizontal support surface 128.

Third tier horizontal support surface 128 and third tier vertical wall 136 may be circular, to accommodate a circular tray, not shown.

Third tier vertical wall 136 may typically have interior diameter 132 in a range of ten to eleven inches.

Device 100 may also further comprise at least one finger hole 126 in at least one of third tier horizontal support surface 128 and third tier vertical wall 136.

Device 100 may further comprise a fourth tier horizontal support surface 140 coupled to a third tier upper edge 142 of third tier vertical wall 136. Fourth tier horizontal support surface 140 may include a fourth tier diameter 144 greater than third tier diameter 132 of third tier horizontal support surface 128, and a fourth tier vertical wall 146 projecting upwardly from a fourth tier upper edge 148.

Fourth tier horizontal support surface 140 and fourth tier vertical wall 146 may be circular.

Fourth tier vertical wall 146 may have fourth tier diameter 144 in a range of twelve to thirteen inches.

Device 100 may further comprise at least one finger hole 126 in at least one of fourth tier horizontal support surface 140 and fourth tier vertical wall 146.

Finally, device 100 may include a fifth tier “support surface” 160 that is not typically used to support a pizza tray. Rather “support surface” 160 is used as a catch area to collect spilled ingredients from a tray, not shown, supported in tier four support surface 140. Spilled ingredients are retained thereupon by upstanding wall 162.

Device 100 may further comprise a bearing assembly 150 between combined, stepped support and splatter arresting wall 102 and base 124. A central open region, not specifically identified, accepts and retains region 170 of combined, stepped support and splatter arresting wall 102. The retention of region 70 centers combined, stepped support and splatter arresting wall 102 in/on bearing assembly 150. Bearing assembly comprises bearings 152. Bearings 152 may comprise ball bearings, roller bearings, or any other suitable bearing devices or materials Device 100 could be compared to a multi-tiered “lazy susan”, wherein ball or roller bearings or the like provide even, smooth rotation. However, if preferred, bearings 152 may comprise interfitting surfaces of combined support and splatter arresting wall 102 and base 150 (this option is not shown).

Third tier horizontal support surface 128 and its associated third tier vertical wall 136, and fourth tier horizontal support surface 140 and its associated fourth tier vertical wall 146 enable device 100 to accommodate most of the nominal pizza diameters currently in commercial use. Diameters and proportions shown and described herein are merely exemplary, and may be varied. For example, the largest tier of combined support and splatter arresting wall 102 may be dimensioned to receive pizza dough bases 12 of sixteen or eighteen inches or more.

While pan 14 and food base 12 are shown resting on second tier horizontal support surface 114, a pan 14 and food base 12 of different dimensions could of course be placed on other horizontal support surfaces of combined support and splatter arresting wall 102. Thus, one combined support and splatter arresting wall 102 accommodates pizzas of different diameters.

Therefore, it will be appreciated that where diameters are called out herein, diameters may be taken at interior or exterior surfaces of vertical walls (e.g., vertical wall 108), or even an innermost edge of a horizontal support surface (e.g., horizontal support surface 114), as long as diameters are compared to corresponding diameters of different tiers. Combined support and splatter arresting wall 102 may be fabricated from aluminum alloy or steel sheet metal, for example. Finger holes 126 may be stamped into combined support and splatter arresting wall 102, and may impinge on both vertical walls (e.g., vertical wall 146) and may extend into associated horizontal support surfaces (e.g., horizontal support surface 140).

Novel device 100 has been described in terms of use in preparing round pizzas, but of course may be used with other food items. For example, combined support and splatter arresting wall 102 may be made rectangular, to accommodate rectangular foods. Foods other than pizza may be prepared. Cakes requiring decorative sprinkles, chocolate chips, and other toppings may utilize device 100. Any food product requiring application of particulate or fluent toppings (e.g., sauces, gravy, melted butter, etc.) may be prepared using device 100.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A tiered pizza tray support and pizza ingredient catch device for controlling particles and splatter from dispensing food ingredients onto a food base, comprising:
a) a combined support and splatter arresting wall comprising: a first tier horizontal support surface including a first tier diameter and a first tier vertical wall projecting upwardly from a first perimeter of said first tier horizontal support surface, said first tier vertical wall including a first upper edge;
b) a second tier horizontal support surface including a second tier diameter greater than said first tier diameter, and a second tier vertical wall projecting upwardly from a second tier perimeter of said second tier horizontal support surface; and
c) a base rotatably coupled to said combined support and splatter arresting wall.

2. The tiered pizza tray support and pizza ingredient catch device as recited in claim 1, wherein both said first tier horizontal support surface and said second tier horizontal support surface are circular.

3. The tiered pizza tray support and pizza ingredient catch device as recited in claim 2, wherein said first tier vertical wall has a first tier diameter in a range of three to four inches, and said second tier vertical wall has a second tier diameter in a range of seven to eight inches.

4. The tiered pizza tray support and pizza ingredient catch device as recited in claim 1, further comprising at least one finger hole in at least one of said first tier horizontal support surface and said first tier vertical wall, and also in at least one of said second tier horizontal support surface and the second tier vertical wall.

5. The tiered pizza tray support and pizza ingredient catch device as recited in claim 1, further comprising a third tier horizontal support surface coupled to a second tier upper edge of said second tier vertical wall, said third tier horizontal support surface including a third tier diameter greater than the second tier diameter of said second tier horizontal support surface, and a third tier vertical wall projecting upwardly from a third tier perimeter of said third tier horizontal support surface.

6. The tiered pizza tray support and pizza ingredient catch device as recited in claim 5, wherein said third tier horizontal support surface is circular and said third tier vertical wall is circular.

7. The tiered pizza tray support and pizza ingredient catch device as recited in claim 6, wherein said third tier vertical wall has a third tier diameter in a range of ten to eleven inches.

8. The tiered pizza tray support and pizza ingredient catch device as recited in claim 5, further comprising at least one finger hole in at least one of said third tier horizontal support surface and said third tier vertical wall.

9. The tiered pizza tray support and pizza ingredient catch device as recited in claim 5, further comprising a fourth tier horizontal support surface coupled to a third tier upper edge of said third tier vertical wall, said fourth tier horizontal support surface including a fourth tier diameter greater than said third tier diameter of said third tier horizontal support surface, and a fourth tier vertical wall projecting upwardly from a fourth tier upper edge.

10. The tiered pizza tray support and pizza ingredient catch device as recited in claim 9, wherein said fourth tier horizontal support surface is circular and said fourth tier vertical wall is circular.

11. The tiered pizza tray support and pizza ingredient catch device as recited in claim 10, wherein said fourth tier vertical wall has a fourth tier diameter in a range of twelve to thirteen inches.

12. The tiered pizza tray support and pizza ingredient catch device as recited in claim 9, further comprising at least one finger hole in at least one of said fourth tier horizontal support surface and said fourth tier vertical wall.

13. The tiered pizza tray support and pizza ingredient catch device ice as recited in claim 1, further comprising a bearing assembly between said combined support and splatter arresting wall and said base, said bearing assembly comprising bearings.

14. The tiered pizza tray support and pizza ingredient catch device as recited in claim 13, wherein said bearings may be one of ball bearings and roller bearings.
